(19) United States
(12) Patent Application Publication
(10) Pub. No.: US 2009/0100464 A1
(43) Pub. Date: Apr. 16, 2009

(54) Content filter

(75) Inventor: Charles J. Migos, San Francisco, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/974,829

(22) Filed: Oct. 16, 2007

(51) Int. Cl. H04N 5/445; G06F 13/00

(52) U.S. Cl. 725/39; 725/56

(57) ABSTRACT

Techniques are described to filter content. In an implementation, channels are filtered according to whether a respective item of content that is currently available via a respective channel complies with one or more criteria. Direct sequential navigation is then provided through a lineup of the filtered channels such that at least one channel having respective content that does not comply with the one or more criteria is not available via the direct sequential navigation.

### BACKGROUND

Users have access to an ever increasing amount and variety of content, which may be provided by digital cable television, satellite television, over the air broadcasts, and so on. As the amount and variety of content continues to expand, however, so too has the difficulty in navigating through this ever increasing range of content to locate particular content of interest, such as a particular television program, movie and so on.

One traditional technique that was used to navigate between channels was through the use of a “channel up” or “channel down” function. However, as the number of channels increased from a handful to well into the hundreds, this technique was oftentimes insufficient to locate particular content of interest in a desired amount of time. For example, a user using this technique may be required to navigate to and view hundreds of television programs before finding a particular television program of interest. As this navigation may take a significant amount of time, the user may miss the particular television program of interest due to the amount of time spent by the user to interact with each of the channels, especially when numbering in the hundreds.

Electronic program guides (EPGs) were also developed to locate content. The EPGs provide functionality similar to printed program guides by informing the users as to which content is available and where that content is located, e.g., what channel is broadcasting a particular television program. However, the EPG is often output separately from the content and therefore navigation through the EPG may require additional steps which are significantly more involved than traditional channel surfing, and therefore may result in a disjointed navigation experience.

### SUMMARY

Techniques are described to filter content. In an implementation, channels are filtered according to whether a respective item of content that is currently available via a respective channel complies with one or more criteria. Direct sequential navigation is then provided through a lineup of the filtered channels such that at least one channel having respective content that does not comply with the one or more criteria is not available via the direct sequential navigation.

In another implementation, electronic program guide (EPG) data is filtered according to one or more criteria. The EPG data describes one or more items of content that are to be available via a channel from a future broadcast. When at least one item of content meets the one or more criteria, a representation is output of the at least one item of content along with a representation of an item of content that is currently available from a broadcast via the channel regardless of whether the item of content meets the one or more criteria.

In a further implementation, one or more computer-readable media include instructions that are executable to provide a mode to enable sequential navigation through channels that include content that meet one or more criteria specified by a user such that at least one channel that includes content that does not meet the one or more criteria is not available via the sequential navigation when in the mode.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to provide content filtering, such as to provide direct sequential navigation through channels that meet one or more criteria.

FIG. 2 is a flow diagram depicting a procedure in an exemplary implementation in which a lineup of channels is built having content that complies with one or more criteria for use in navigating the channels.

FIG. 3 is an illustration of an exemplary implementation of a user interface having an electronic program guide and a portion to initiate a content filtering mode.

FIG. 4 is an illustration of an exemplary implementation of a user interface, output in response to selection of the portion of the user interface of FIG. 3, which is configured to accept one or more inputs to specify criteria to filter content.

FIG. 5 is an illustration of an exemplary implementation of a user interface having filtered content due to selection of criteria using the user interface of FIG. 4.

FIG. 6 is a flow diagram depicting a procedure in an exemplary implementation in which future content is filtered using one or more criteria and displayed concurrently with a representation of content currently being broadcast via a respective channel regardless of whether the current content meets the criteria.

FIG. 7 is an illustration of an exemplary implementation of a user interface having filtered future content displayed along with a representation of content currently being broadcast regardless of whether the current content meets criteria used to filter the future content.

### DETAILED DESCRIPTION

Overview

As the number of choices for content continues to expand, so too does the difficulty in locating particular content of interest. A user, for instance, may surf through each of the channels that are available via a broadcast to locate particular content, such as a desired television program. As the number of channels continues to increase, however, the user may spend a significant amount of time to locate the particular content.

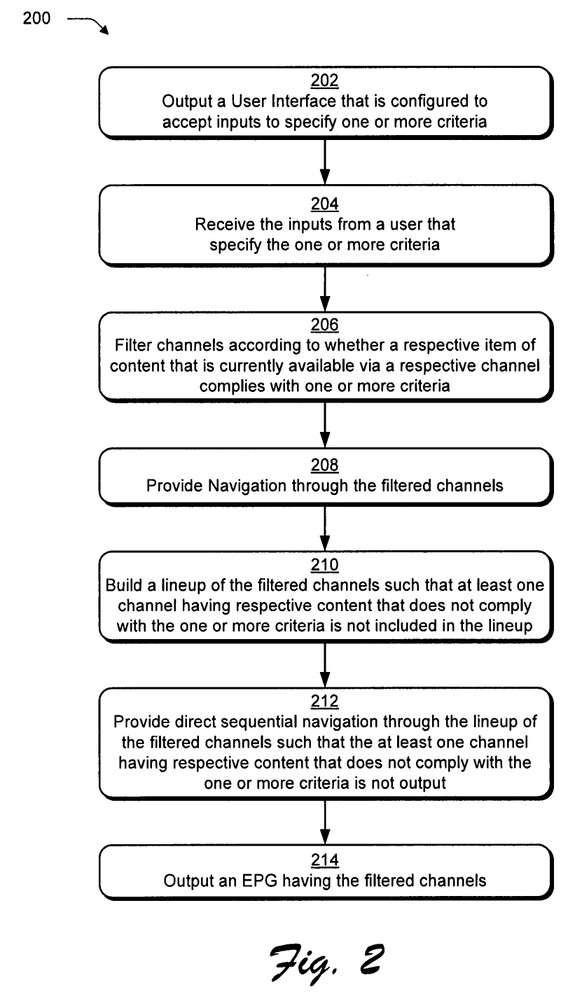

Techniques are described to filter content, which may be used to improve content navigation. In an implementation, content is filtered based on one or more criteria, such as “sports”. Channels that meet the criteria are then arranged into a lineup such that direct sequential navigation may be performed between the channels. Continuing with the previous example, a user may “surf” through the channels using a “channel up” or “channel down” button to view particular channels that relate to sports. In this way, the channel surfing experience may be preserved yet still allow a user to locate desired content. Further discussion of content filtering techniques using one or more criteria may be found in relation to FIGS. 2-5.

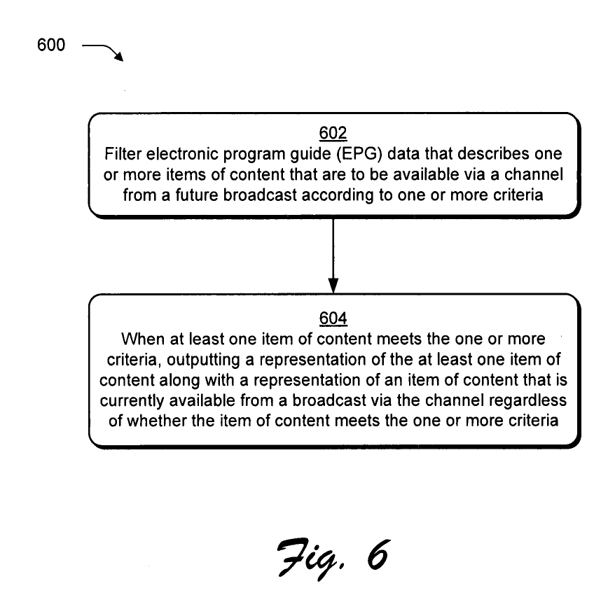

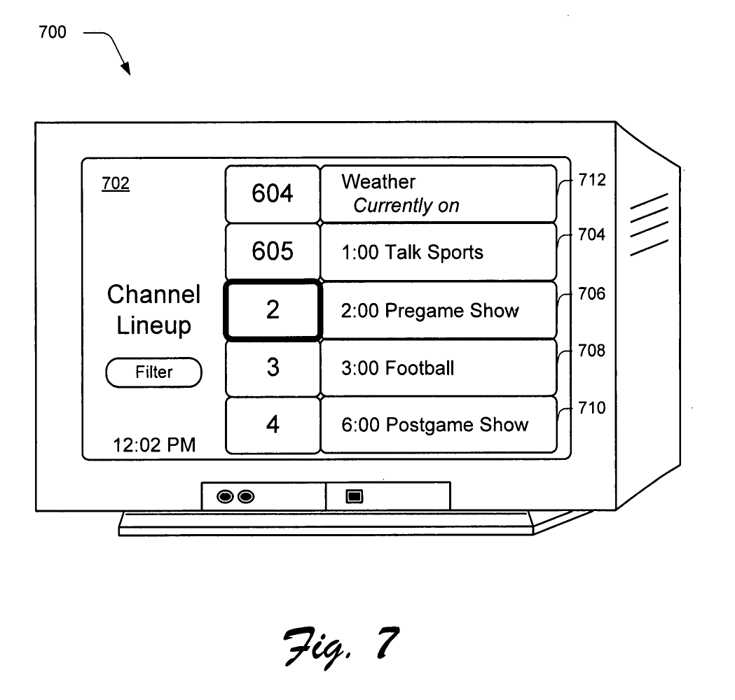

In another implementation, content filtering techniques are applied to content to be displayed in the future, with current content that is available via respective channels being displayed regardless of whether it “matches” the criteria. For instance, an electronic program guide (EPG) may be output that includes representations of currently available content along with representations of “future” filtered content. In this way, a user is able to view currently available content as well as search through content that is available in the future. Further discussion of content filtering techniques that display currently available content regardless of the criteria used to filter future content may be found in relation to FIGS. 6-7.

In the following discussion, an exemplary environment is first described that is operable to perform techniques to provide navigation using filtering techniques. Exemplary procedures are then described that may be employed in the exemplary environment, as well as in other environments. Although these techniques are described as employed within a television environment in the following discussion, it should be readily apparent that these techniques may be incorporated within a variety of environments without departing from the spirit and scope thereof.

Exemplary Environment

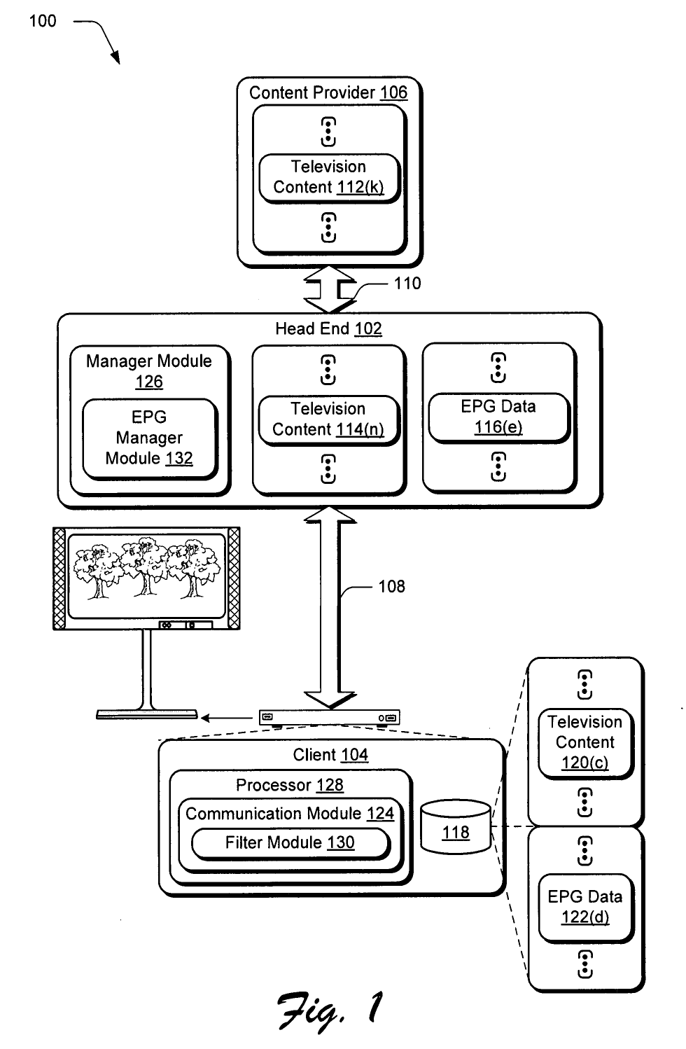

FIG. 1 is an illustration of an environment 100 in an exemplary implementation that is operable to provide content filtering, such as to provide direct sequential navigation through channels that meet one or more criteria. The illustrated environment 100 includes a head end 102 of a network operator, a client 104 and a content provider 106 that are communicatively coupled, one to another, via network connections 108, 110. In the following discussion, the head end 102, the client 104 and the content provider 106 may be representative of one or more entities, and therefore reference may be made to a single entity (e.g., the client 104) or multiple entities (e.g., the clients 104, the plurality of clients 104, and so on). Additionally, although a plurality of network connections 108, 110 are shown separately, the network connections 108, 1 10 may be representative of network connections achieved using a single network or multiple networks. For example, network connection 108 may be representative of a broadcast network with back channel communication, an Internet Protocol (IP) network, and so on.

The client 104 may be configured in a variety of ways. For example, the client 104 may be configured as a computer that is capable of communicating over the network connection 108, such as a desktop computer, a mobile station, an entertainment appliance, a set-top box communicatively coupled to a display device as illustrated, a wireless phone, and so forth. For purposes of the following discussion, the client 104 may also relate to a person and/or entity that operate the client. In other words, client 104 may describe a logical client that includes a user, software and/or a machine.

The content provider 106 includes one or more items of television content 112(k), where “k” can be any integer from 1 to “K”. The television content 112(k) may include a variety of data, such as television programming, video-on-demand (VOD) files, and so on. The television content 112(k) is communicated over the network connection 110 to the head end 102. In the following discussion, it should be readily apparent that television content may also be referred to simply as “content” and is but one example of a variety of different types of content, such as radio content.

Television content 112(k) communicated via the network connection 110 is received by the head end 102 and may be stored as one or more items of television content 114(n), where “n” can be any integer from “1” to “N”. The television content 114(n) may be the same as or different from the television content 112(k) received from the content provider 106. The television content 114(n), for instance, may include additional data for broadcast to the client 104, such as metadata that describes the content 112(k).

Another example of this additional data is illustrated in FIG. 1 as electronic program guide (EPG) data 116(e), where “e” can be any integer from one to “E”. The EPG data 116(e) may be obtained from an EPG database for broadcast to the client 104, such as through use of a carousel file system. The carousel file system repeatedly broadcasts the EPG data over an out-of-band (OOB) channel to the client 104 over the network connection 108. Distribution from the head end 102 to the client 104 may be accommodated in a number of ways, including cable, radio frequency (RF), microwave, digital subscriber line (DSL), satellite, via Internet Protocol (IP) connection, and so on. Although the EPG data 116(e) is illustrated as being provided by the head end 102 for the sake of simplicity of the figure, it should be readily apparent that the EPG data 116(e) may originate from a wide variety of sources, such as a stand alone third-party provider.

The client 104, as previously stated, may be configured in a variety of ways to receive the television content 114(n) and the EPG data 116(e) over the network connection 108. The client 104 typically includes hardware and software to transport and decrypt content 114(n) and the EPG data 116(e) received from the head end 102 for rendering by the illustrated display device. Although a display device is shown, a variety of other output devices are also contemplated, such as speakers.

The client 104 may also include digital video recorder (DVR) functionality. For instance, the client 104 may include memory 118 to record television content 114(n) as television content 120(c) (where “c” can be any integer from one to “C”) received via the network connection 108 for output to and rendering by the display device. The memory 118 may be configured in a variety of ways, such as a hard disk drive, a removable computer-readable medium (e.g., a writable digital video disc), semiconductor based memory, and so on. Thus, television content 120(c) that is stored in the memory 118 of the client 104 may be copies of the television content 114(n) that was streamed from the head end 102. Additionally, the memory 118 may also be used to store EPG data 116(e) as EPG data 122(d), where “d” can be any integer from one to “D”.

The client 104 includes a communication module 124 that is executable on the client 104 to control content playback on the client 104, such as through the use of one or more “command modes”, i.e., “trick modes”, to tune to a particular channel, order pay-per-view content, and so on. The command modes may provide non-linear playback of the content 120(c) (i.e., time shift the playback of the content 120(c)) such as pause, rewind, fast forward, slow motion playback, and the like.

The head end 102 is illustrated as including a manager module 126. The manager module 126 is representative of functionality to configure television content 114(n) for output (e.g., streaming) over the network connection 108 to the client 104. The manager module 126, for instance, may configure content 112(k) received from the content provider 106 to be suitable for transmission over the network connection 108, such as to “packetize” the content for distribution over the Internet, configuration for a particular broadcast channel, map the television content 112(k) to particular channels, and so on.

Thus, in the environment 100 of FIG. 1, the content provider 106 may broadcast the television content 112(k) over a network connection 110 to a multiplicity of network operators, an example of which is illustrated as head end 102. The head end 102 may then stream the television content 114(n) over a network connection to a multitude of clients, an example of which is illustrated as client 104. The client 104 may then store the television content 114(n) in the memory 118 as television content 120(c) and/or render the television content 114(n) immediately for output as it is received, such as when the client 104 is configured to include digital video recorder (DVR) functionality.

The client is illustrated as executing the communication module 124 on a processor 128, which is also storable in memory 118. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Additionally, although a single memory 118 is shown for the client 104, a wide variety of types and combinations of memory may be employed, such as random access memory (RAM), hard disk memory, removable medium memory, and other types of computer-readable media.

The communication module 124 is also illustrated as including a filter module 130 which is representative of functionality that may be employed to filter television content 114(N), 120(c) to locate particular content of interest. For example, the filter module 130 may be employed to initiate a mode to generate and manage an EPG from the EPG data 122(d). For instance, the EPG module 130 may receive EPG data 116(e) from the head end 102 (e.g., directly and/or from memory 118 as EPG data 122(d)) and process the data to create and output an EPG.

The filter module 130 may then be utilized to provide filter functionality related to the EPG data 122(d). For example, the filter module 130 may accept a collection of characters (e.g., keywords) as input by a user to define one or more criteria. These criteria may then be used to locate EPG data 122(d) that corresponds to the collection and thus television content described by the EPG data 122(d). Results of this search may be provided in a variety of ways.

In an implementation, the EPG data 122(d) is arranged to provide direct sequential navigation. For example, the channels that include content that corresponds to the criteria may be used to create a “lineup” of channels. A user may then sequentially navigate directly through the channels, such as by using a “channel up” or “channel down” button and is “direct” in that a channel number need not be manually entered by a user to navigate to a next channel. In this way, a channel surfing experience is preserved while allowing the user to efficiently locate desired content using the criteria. In another example, the filter may be used to provide an EPG having content that correspond to the desired criteria, e.g., letters of a desired keyword or any other property.

In another implementation, the filter module 130 is representative of functionality to filter channels for future broadcasts. Content that meets the criteria are then displayed (e.g., in an EPG) along with content that is currently available regardless of whether the currently available content corresponds to the criteria. Thus, a user may be readily informed as to what is currently being broadcast via particular channels as well as locate “future” content, further discussion of which may be found in relation to FIG. 6.

It should be noted that the following discussion describes whether content corresponds to particular criteria, which may be performed in a variety of ways. For example, content that is within a certain genre (e.g., sports) may be considered to correspond to the criteria “sports”. In another example, content that is not within the certain genre (e.g., sports) may also be considered to correspond to the criteria “not sports”. A variety of other properties are also contemplated, such as actors, directors, textual descriptions, format, quality, and so on.

It should also be noted that one or more of the entities shown in FIG. 1 may be further divided (e.g., the head end 102 may be implemented by a plurality of servers in a distributed computing system), combined (e.g., the head end 102 may incorporate functionality of the filter module 130 to filter content), and so on and thus the environment 100 of FIG. 1 is illustrative of one of a plurality of different environments that may employ the described techniques.

Generally, any of the functions described herein can be implemented using software, firmware, hardware (e.g., fixed-logic circuitry), manual processing, or a combination of these implementations. The terms “module”, “functionality”, “engine” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices. The features of the techniques to provide content filtering are platform-independent, meaning that the techniques may be implemented on a variety of commercial computing platforms having a variety of processors.

Exemplary User Interfaces and Procedures

The following discussion describes content filtering techniques that may be implemented utilizing the previously described environment, systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1. The following discussion also describes exemplary user interfaces that may be output by the previously described exemplary environment, as well as other environments. Thus, although portions of the following discussion refer to the environment 100 of FIG. 1, the following discussion should not necessarily be limited to that environment 100.

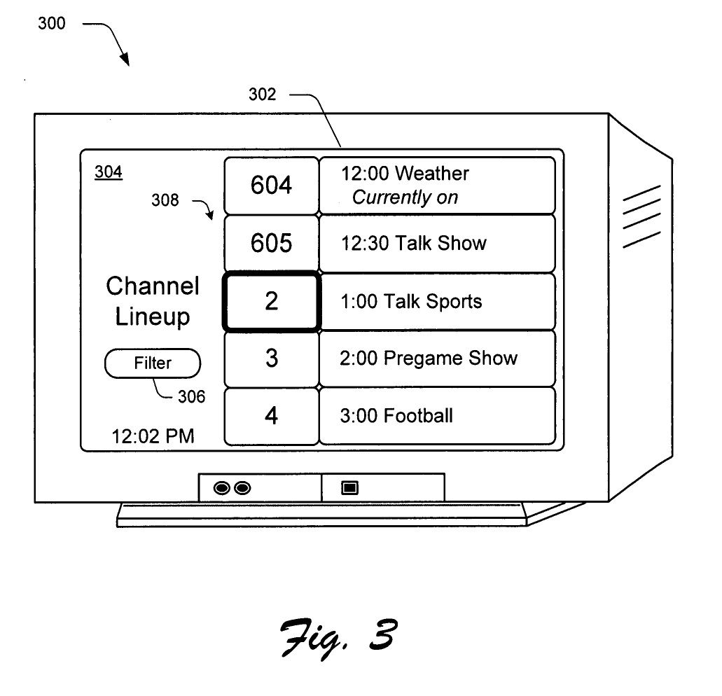

FIG. 2 depicts a procedure 200 in an exemplary implementation in which a lineup of channel is built having content that complies with one or more criteria for using in navigating the channels. A user interface is output that is configured to accept inputs to specify one or more criteria (block 202). For example, FIG. 3 is an illustration of an exemplary implementation 300 of a user interface 302 having an electronic program guide 304 and a portion 306 to initiate a mode to filter content. Although a portion 306 is illustrated, a variety of other techniques may be used to initiate filtering, such as by pressing a dedicated button on a remote control. The electronic program guide 304 includes a listing 308 of channels from which the client 104 may receive television content.

Channel 2 is illustrated as having focus in FIG. 3, thereby causing television content 114(n) available via that channel to be displayed in a vertical column to the right of the listing 308. The current time in the illustrated example is “12:02 PM”, and the television content available via channel 2 is illustrated as “Weather”, “Talk Show”, “Talk Sports”, “Pregame Show” and “Football” at times of 12:00, 12:30, 1:00, 2:00 and 3:00, respectively. Upon selection of the portion 306, a user interface may be output to filter content, an example of which if shown in the following figure.

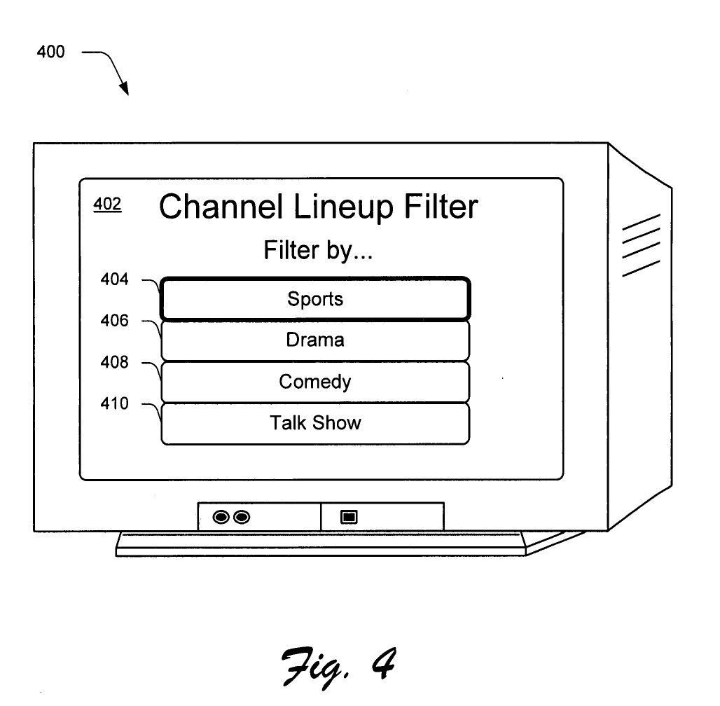

FIG. 4 is an illustration of an exemplary implementation 400 of a user interface 402 that is output in response to selection of the portion 306 of the user interface 302 of FIG. 3. The user interface 402 is configured to accept one or more inputs to specify criteria to filter content. In the illustrated example, the criteria are illustrated as sports 404, drama 406, comedy 408 and talk show 410. A user may then select between one or more of these criteria 404-410 to filter content according to the criteria, which is illustrated as selection of sports 404 criterion through the use of focus in FIG. 4. Although different genre categories are illustrated, a variety of different criteria may be specified, such as any property that may be used to define content available via a particular channel, e.g., actor, author, director, textual description, and so on. Thus, inputs may be received from a user that specifies the one or more criteria (block 204).

Channels are then filtered according to whether a respective item of content that is currently available via a respective channel complies with one or more criteria (block 206). Data that is used to base whether or not an item of content complies may be obtained from a variety of sources. For example, the filter module 130 may examine EPG data 122(d) that describes television content 120(c) recorded in storage. In another example, the filter module 130 may examine metadata associated with the television content 114(n), such as metadata that is streamed with the television content 114(n) from the head end 102 or obtained from a variety of other sources, such as a third-party provider. A variety of other examples are also contemplated.

Further, the determination may be made in a variety of ways. For instance, the criteria used to filter the content may be based on a variety of properties, such as genre, actor, textual description, plot, director, output format (e.g., MPEG, high-definition, standard definition), source of the content (e.g., an over-the-air broadcast, video on demand, IP-based network, digital cable television, satellite, locally from a digital video recorder), and so forth.

Navigation through the filtered channels may then be provided (block 208) in a variety of ways. For example, a lineup may be built of the filtered channels such that at least one channel having respective content that does not comply with the one or more criteria is not included in the lineup (block 210). Direct sequential navigation through the lineup of the filtered channels may then be provided such that the at least one channel having respective content that does not comply with the one or more criteria is not output (block 212).

Continuing with the previous example, a criterion “sports” may be used to filter content available via currently broadcast channels by comparing metadata and/or EPG data that describe the content for compliance with the criteria. Channels having content that “meets” the criterion are then included in a lineup of filtered channels.

Direct sequential navigation may then be provided using this lineup of filtered channels such that channels which do not have currently broadcast content that meet the criterion (e.g., sports) are not included in the navigation. For instance, a user may use a “channel up” or “channel down” button to navigate sequentially between the channels without displaying an EPG. Therefore, when a user presses a “channel up” button a next highest numbered channel may be displayed that currently includes sports television content. Likewise, “channel down” may be provided to navigate to a “next lower” channel having sports television content that is currently available via the channel. Naturally, a “jump” may be performed when a sequentially numbered lower or higher channel is not available for channel down or channel up navigation, respectively. A variety of other instances are also contemplated.

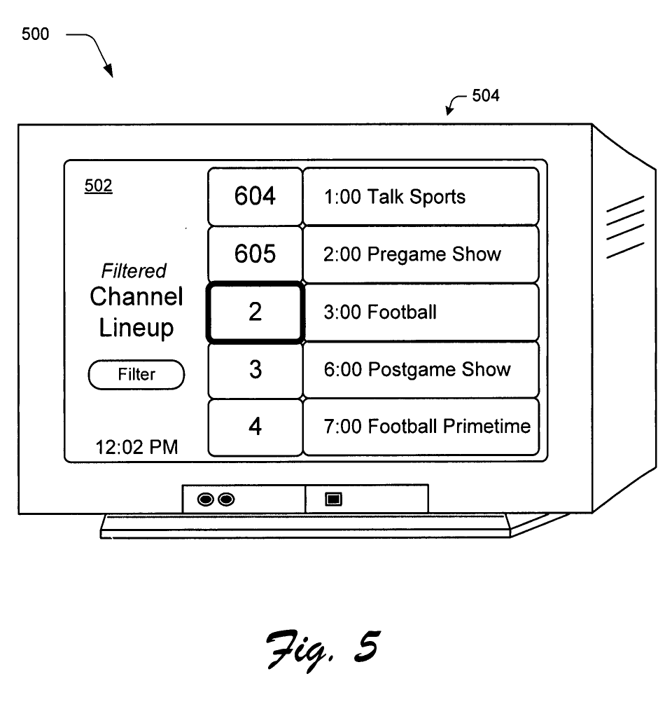

An EPG, for instance, may also be output having the filtered channels (block 214), as shown in FIG. 5. FIG. 5 is an illustration of an exemplary implementation 500 of a user interface 502 having representations 504 of filtered content due to selection of one or more criteria using the user interface 402 of FIG. 4. In the illustrated user interface 502 of FIG. 5, representations 504 of television content that corresponds to the “sports” criterion are output for channel “2”. Therefore, as a user navigates through the column of channels of FIG. 5, one or more representations 504 of content that comply with the criterion are displayed in a column to the right of the column of channels. It should be readily apparent that a variety of other arrangements are also contemplated without departing from the spirit and scope thereof, such as through output using a tradition grid array, a sequential list of search results for each channel arranged by time, and so on.

FIG. 6 depicts a procedure 600 in an exemplary implementation in which future content is filtered using one or more criteria and displayed concurrently with a representation of content currently being broadcast via a respective channel regardless of whether the current content meets the criteria. Electronic program guide (EPG) data is filtered that describes one or more items of content that are to be available via a channel from a future broadcast accordingly to one or more criteria (block 602). The EPG data 116(e), for instance, may be obtained from a head end 102, a “stand alone” third-party provider, and so on. As previously described, a variety of criteria may be utilized to specify properties that pertain to content.

When at least one item of content meets the one or more criteria, a representation of the alt least one item of content is output along with a representation of an item of content that is currently available from a broadcast via the channel regardless of whether the item of content meets the one or more criteria (block 604). Thus, a user may be readily informed as to what is currently being broadcast as well as filter content to locate particular content of interest in the future, an example of which may be found in the following figure.

FIG. 7 is an illustration of an exemplary implementation 700 of a user interface 702 having representations 704-710 of filtered future content displayed along with a representation 712 of content currently being broadcast regardless of whether the current content meets criteria used to filter the future content. Continuing again with the previous example, the criterion “sports” is used to filter future content, representations of which include “talk sports” 704, “pregame show” 706, “football” 708 and “postgame show” 710.

Even though the television content “weather” does not comply with the criterion “sports”, a representation 712 of “weather” is also displayed in the user interface 702. As before, navigation through the column of channels may cause output of corresponding content for the channels, although other arrangements are also contemplated such as traditional grid arrays and so on.

### Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
filtering channels according to whether a respective item of content that is currently available via a respective said channel complies with one or more criteria; and
providing direct sequential navigation through a lineup of the filtered said channels such that at least one said channel having respective said content that does not comply with the one or more criteria is not available via the direct sequential navigation.

2. A method as described in claim 1, wherein the lineup of the filtered channels provides a sequential ordering of channels that comply with the one or more criteria according to channel number.

3. A method as described in claim 1, wherein the filtering is performed by examining metadata associated with corresponding said content available via the respective said channel.

4. A method as described in claim 3, wherein the metadata is obtained from a head end that is to broadcast the corresponding said content via the respective said channels.

5. A method as described in claim 1, wherein the providing of the direct sequential navigation is performed without output of an electronic program guide (EPG).

6. A method as described in claim 1, wherein the providing of the direct sequential navigation includes use of a channel up or channel down function.

7. A method as described in claim 1, wherein the providing of the direct sequential navigation is performed without manual entry of a channel number by a user.

8. A method as described in claim 1, wherein:
the at least one said channel having respective said content that does not comply with the one or more criteria has a channel number that is between a channel number of a first said channel having respective said content that does comply with the one or more criteria and a second said channel having respective said content that does comply with the one or more criteria; and
the providing of the direct sequential navigation is performed such that sequential navigation is performed from the first said channel to the second said channel directly without outputting the respective said content of the at least one said channel.

9. A method as described in claim 1, further comprising outputting a user interface that is configured to receive one or more inputs that specify the one or more criteria.

10. A method comprising:
filtering electronic program guide (EPG) data that describes one or more items of content that are to be available via a channel from a future broadcast according to one or more criteria; and
when at least one said item of content meets the one or more criteria, outputting a representation of the at least one said item of content along with a representation of an item of content that is currently available from a broadcast via the channel regardless of whether the item of content meets the one or more criteria.

11. A method as described in claim 10, wherein the representation of the at least one said item of content and the representation of the item of content that is currently available from the broadcast are included in an electronic program guide (EPG).

12. A method as described in claim 10, wherein the representation of the at least one said item of content and the representation of the item of content that is currently available from the broadcast via the channel are not output with another representation of an item of content available via another channel.

13. A method as described in claim 10, wherein the representation of the at least one said item of content and the representation of the item of content that is currently available from the broadcast via the channel are output with another representation of an item of content available via another channel in a grid array.

14. A method as described in claim 13, wherein the other representation of an item of content available via the other channel meets the one or more criteria.

15. One or more computer-readable media comprising instructions that are executable to provide a mode to enable sequential navigation through channels that include content that meet one or more criteria specified by a user such that at least one said channel that includes content that does not meet the one or more criteria is not available via the sequential navigation when in the mode.

16. One or more computer-readable media as described in claim 15, wherein the computer executable instructions are further executable to output a user interface to specify the one or more criteria by the user.

17. One or more computer-readable media as described in claim 15, wherein the computer executable instructions are further executable on a client configured as a set-top box to receive an input that is originated by a remote control associated with the set-top box to initiate the mode.

18. One or more computer-readable media as described in claim 15, wherein the sequential navigation is performed directly without output of an electronic program guide (EPG).

19. One or more computer-readable media as described in claim 15, wherein the sequential navigation includes use of a channel up or channel down function.

20. One or more computer-readable media as described in claim 15, wherein the sequential navigation is performed without manual entry of a channel number by a user.
